(19) United States
(12) Patent Application Publication
(10) Pub. No.: US 2011/0284484 A1
(43) Pub. Date: Nov. 24, 2011

(54) Cam-lock assembly for adjustable length tubes

(76) Inventors: Ching-Chang Lin, San Chung City (TW); Tung Shih, Huatan Township (TW)

(21) Appl. No.: 12/800,655

(22) Filed: May 20, 2010

(51) Int. Cl. A47B 81/00; A47B 57/06; F16B 7/10

(52) U.S. Cl. 211/45; 403/202; 211/207; 211/86.01

(57) ABSTRACT

A device includes a cam-lock assembly located at an end of an inner tube inserted into an outer tube. The inner tube and the outer tube slide with respect to one another to adjust an overall length when the cam-lock assembly is in a released position, and rotation of one of the inner tube and the outer tube engages the cam-lock assembly such that the inner tube and the outer tube are fixed at a particular length.

### BACKGROUND

The present invention relates generally to storage devices and more specifically to storage devices having adjustable length tubes.

Various types of conventional furniture for organizing and storing personal items exist. For example, linens and toiletries are frequently stored on shelving or in drawers either within or near a bathroom. Shelving and/or drawers can be built below a sink, hung on a wall or around a shower head, or stand alone as a unit on the floor. Space for storage is often limited, particularly in older houses with smaller rooms. A lack of adequate storage solutions can lead to disorganization and loss of everyday personal items.

### SUMMARY

One embodiment of the present invention is a device including an inner tube, an outer tube, and a cam-lock assembly located at an end of the inner tube inserted into the outer tube. The cam-lock assembly includes a spool and an eccentric bushing surrounding the spool. The inner tube and the outer tube slide with respect to one another to adjust an overall length of the device when the eccentric bushing is in a released position. Rotation of one of the inner tube and the outer tube engages the eccentric bushing to drive it around the spool into a locked position such that the first tube and the second tube are fixed at a particular length.

The cam-lock assembly can include a first flange attached to the end of the inner tube, a second flange coaxial with the first flange, and a cylindrical post extending between the first flange and the second flange. The first flange and the second flange have diameters similar to a diameter of the inner tube. The cylindrical post is offset from the common axis of the first flange and the second flange. An area surrounding the cylindrical post forms a track and an eccentric bushing is located in the track.

Another embodiment of the present invention is a storage assembly including a plurality of tubes, at least one storage apparatus attached to one of the plurality of tubes, and a cam-lock assembly. The plurality of tubes includes an inner tube and an outer tube telescopically engaged with one another to adjust an overall length of the unit. The cam-lock assembly is located at an end of the inner tube inserted into the outer tube. Rotation of one of the inner tube and the outer tube engages the cam-lock assembly such that the first tube and the second tube are fixed at a particular length.

### BRIEF DESCRIPTION OF THE DRAWINGS

FIG. 1 is a perspective view of a storage device in accordance with the present disclosure.

FIG. 2 is a perspective view of a plurality of tubes being assembled to from the storage device of FIG. 1.

FIGS. 3A-3D are perspective views of retaining members being attached to the plurality of tubes of FIG. 2 to form the storage device of FIG. 1.

FIG. 4 is a perspective view of a tube being attached to the plurality of tubes of FIG. 2 to form the storage device of FIG. 1.

FIGS. 5A-5B are perspective views illustrating how the plurality of tubes for the storage device of FIG. 1 are adjustable in length.

FIG. 6 is a close-up side view of the plurality of tubes having adjustable length as shown in FIGS. 5A-5B.

FIG. 7A is an exploded view and FIG. 7B is an assembled view of a cam-lock assembly for use in the plurality of tubes of FIG. 6.

FIG. 8A is a perspective view and FIG. 8B is a top view of the cam-lock assembly of FIGS. 7A-7B in a released position.

FIG. 9A is a perspective view and FIG. 9B is a top view of the cam-lock assembly of FIGS. 7A-7B approaching a locked position.

FIGS. 10A-10B are perspective views of an alternative storage device having adjustable length tubes in accordance with the present disclosure.

FIGS. 11A-11B are perspective views of an alternative storage device having adjustable length tubes accordance with the present disclosure.

FIG. 12 is a perspective view of an alternative storage device having adjustable length tubes in accordance with the present disclosure.

### DETAILED DESCRIPTION

The storage device of the present disclosure includes telescoping tubes, which are adjustable in length to fit the storage device within a given space. The telescoping tubes have an internal cam-lock assembly that can occupy either a released or a locked position. When in the released position, the cam-lock allows for sliding movement of the telescoping tubes to adjust the overall length of the storage device. When occupying the locked position, the cam-lock fixes the telescoping tubes with respect to one another and therefore, the length of the storage device.

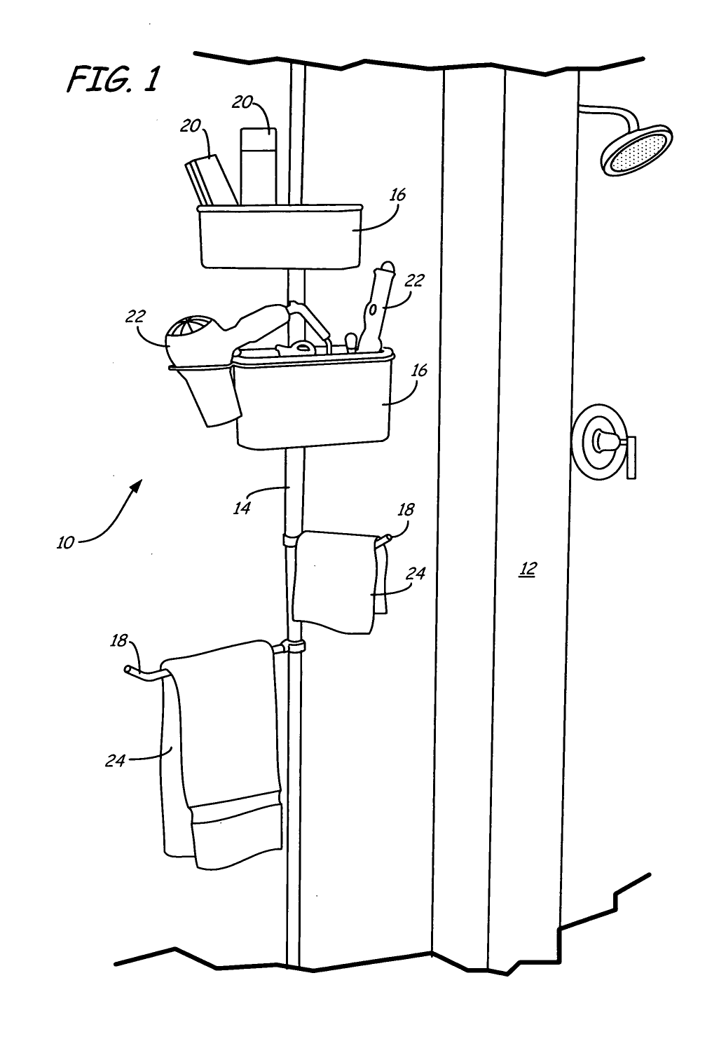

FIG. 1 is a perspective view of storage device 10 located within bathroom 12. Storage device 10 includes tubes 14, baskets 16, and bars 18. Associated with storage device 10 are items commonly found in bathroom 12: toiletries 20, electrical handheld devices 22, and towels 24. Storage device 10 is placed within bathroom 12 to organize and store items such as toiletries 20, devices 22, and towels 24.

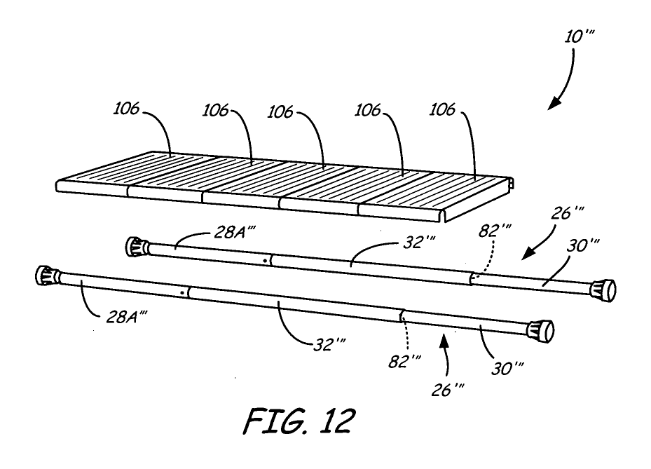

Storage device 10 includes a plurality of tubes 14 extending vertically between a ceiling and a floor of bathroom 12, although the invention is not so limited (see FIG. 12). At least two of tubes 14 are telescoping and adjustable in length. Tubes 14 can be formed from any material such as metal or plastic. Extending horizontally from tubes 14 are baskets 16 and bars 18, which can also be formed from any material such as metal or plastic. Baskets 16 and bars 18 are attached to tubes 14 at spaced intervals to retain items used in bathroom 12. In the depicted embodiment, first basket 16 contains toiletries 20 such as a bottle of lotion and a tube of toothpaste, second basket 16 contains devices 22 such as a curling iron and a hair dryer, first towel bar 18 supports small towel 24 such as a washcloth, and second towel bar 18 supports large towel 24 such as a bath towel. Storage device 10 both organizes and retains items used in bathroom 12.

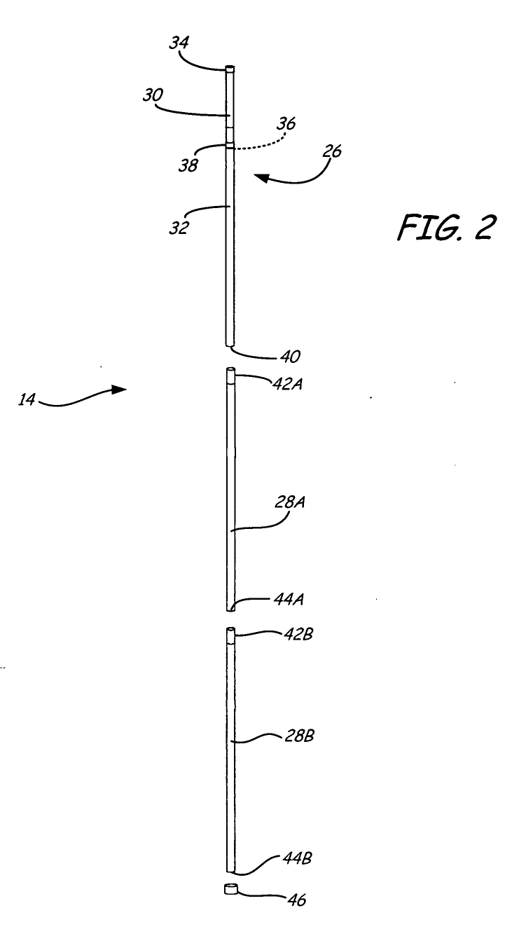

FIG. 2 is a perspective view of tubes 14 being assembled to form storage device 10, with baskets 16 and bars 18 removed. Tubes 14 for storage device 10 include telescoping tube section 26, first straight tube 28A, and second straight tube 28B. Telescoping tube section 26 can be further divided into inner telescoping tube 30 and outer telescoping tube 32. Each of tubes 14 includes two ends: inner telescoping tube 30 has first end 34 and second end 36, outer telescoping tube 32 has first end 38 and second end 40, first straight tube 28A has first end 42A and second end 44A, and second straight tube 28B has first end 42B and second end 44B. End cap 46 is located at second end 44B of straight tube 28B. When assembled, tubes 14 form the structure of storage device 10 for retaining and organizing personal items.

In the depicted embodiment, tubes 14 are oriented vertically to assemble storage device 10 of FIG. 1. Telescoping tube section 26 are placed above first straight tube 28A, which is placed above second straight tube 28B. More specifically, first end 34 of inner telescoping tube 30 faces a first direction, such as a ceiling. Second end 36 of inner telescoping tube 30 faces a second direction, such as a floor. Second end 36 of inner telescoping tube 30 is inserted into first end 38 of outer telescoping tube 32, such that inner telescoping tube 30 and outer telescoping tube 32 are joined together and form telescoping tube section 26. In one embodiment, inner telescoping tube 30 and outer telescoping tube 32 each have a length of about 23 inches (50.42 cm). Inner telescoping tube 30 has a diameter of about 0.78 inches (1.98 cm) and outer telescoping tube 32 has a diameter of about 0.88 inches (2.24 cm). When joined together, second end 36 of inner telescoping tube 30, having the smaller diameter, can slide into and out of first end 38 of outer telescoping tube 32 to adjust the overall length of telescoping tube section 26 from about 46 inches (116.8 cm) to about 24.5 inches (62.23 cm).

Joined to a second side of telescoping tube section 26 are first straight tube 28A and second straight tube 28B. First straight tube 28A and second straight tube 28B are identical and each about 24 inches (60.96 cm) long. First ends 42A, 42B of straight tubes 28A, 28B, respectively, have diameters of about 0.88 inches (2.24 cm) and second ends 44A, 44B have reduced diameters of about 0.78 inches (1.98 cm). Second end 40 of outer telescoping tube 32 faces the second direction to join with first end 42A of first straight tube 28A. Since first end 42A of first straight tube 28A has a reduced diameter in comparison to second end 40 of outer telescoping tube 32, first end 42A of first straight tube 28A is received into second end 40 of outer telescoping tube 32. Similarly, first end 42B of second straight tube 28B is received into second end 44A of first straight tube 28A. Second end 44B of second straight tube 28B is received into end cap 46, which can be formed from plastic and is configured to contact the floor or any other surface such as a ridge of bathtub. So assembled, tubes 14 form the vertical structure of storage device 10.

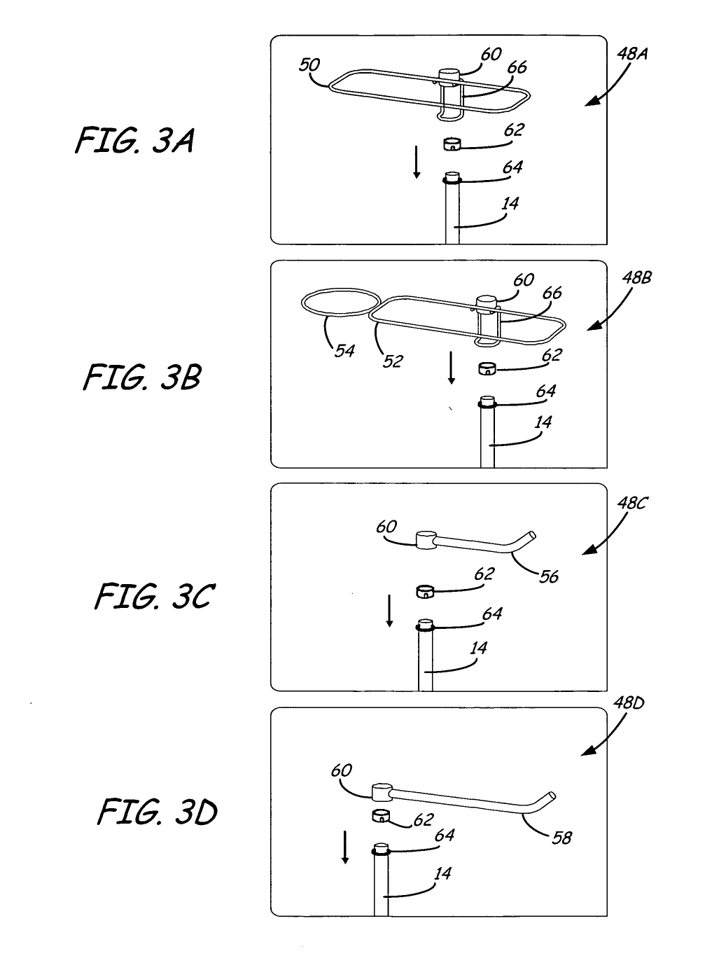

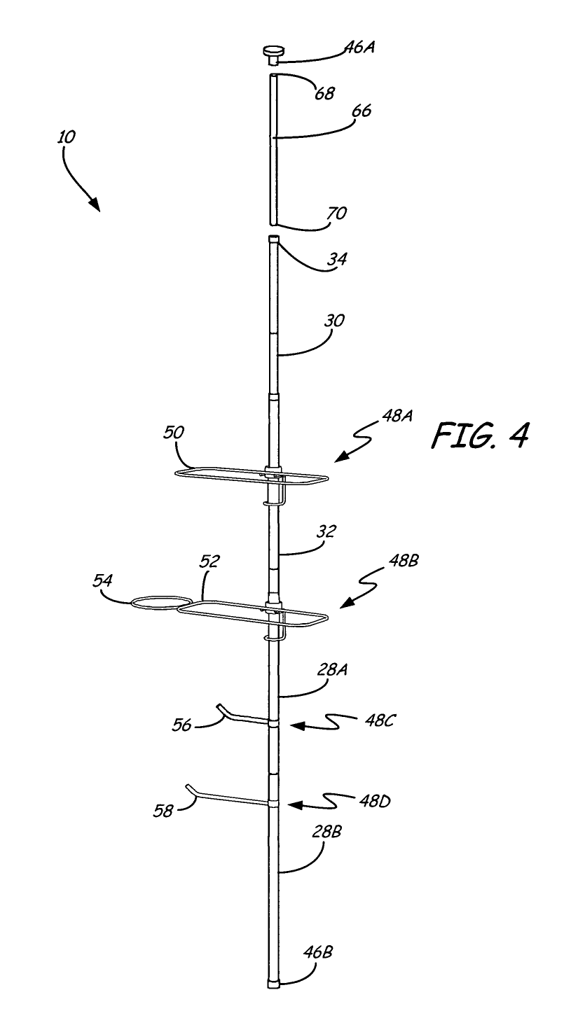

FIGS. 3A-3D are perspective views of various retaining members 48A-48D being attached to tubes 14 to form storage device 10. In FIG. 3A, retaining member 48A is basket holder 50. In FIG. 3B, retaining member 48B is basket holder 52 having ring 54. In FIG. 3C, retaining member 48C is small towel bar 56. In FIG. 3D, retaining member 48D is large towel bar 58. Each retaining member 48A-48D includes attachment sleeve 60 for surrounding inner cap 62 and rubber ring 64. Additional supports extend downwardly from attachment sleeves 60 of basket holders 50 and 52. Retaining members 48A-48D can be placed at desired locations along tubes 14 to store and organize personal items.

Retaining members 48A-48D can be formed from metal or plastic. As shown in FIG. 3A, basket holder 50 is primarily rectangular in shape and has rounded corners. Two longer sides of basket holder 50 are about 9 inches (22.86 cm) long and two shorter sides of basket holder 50 are about 3.5 inches (8.89 cm) long. Attached centrally along one of the longer sides of basket holder 50 is attachment sleeve 60. Attachment sleeve 60 has an outer diameter of about 1.25 inches (3.18 cm) and a central aperture with a diameter of about 1.18 inches (3 cm). Attached to basket holder 50 on both sides of attachment sleeve 60 is support 66. Support 66 extends downwardly at an approximately right angle from both sides of attachment sleeve 60. The two sides of support 66 join to form a semi-circle about 1.75 inches (4.45 cm) below basket holder 50 and attachment sleeve 60. Located just beneath support 66 is inner cap 62 having an outer diameter of about 1.18 inches (3 cm) and an inner diameter of about 1 inch (2.54 cm). Just beneath inner cap 62 and surrounding tube 14 is rubber ring 64 having a diameter of about 0.88 inches (2.24 cm).

To attach any of retaining members 48A-48D to one of tubes 14, rubber ring 64 is placed over an end of tube 14 so that rubber ring 64 surrounds tube 14. Rubber ring 64 is slid along tube 14 to a desired location for retaining member 48. Next, inner cap 62 is slid over the open end of tube 14 and onto rubber ring 64 so that inner cap 62 surrounds rubber ring 64. The diameters of tube 14, inner cap 62, and rubber ring 64 are such that rubber ring 64 stops movement of inner cap 62 with regards to tube 14. Last, attachment sleeve 60 is slid over the open end of tube 14 and onto inner cap 62 so that attachment sleeve 60 surrounds inner cap 62, thereby securing retaining member 48 to tube 14. In the instances of basket holders 50, 52, support 66 extends downwardly from attachment sleeve 60 and therefore, support 66 surrounds tube 14 prior to sliding attachment sleeve 60 over inner cap 62. Support 66 distributes weight from attachment sleeve 60 and basket holders 50, 52 to tube 14 thereby providing additional stability.

Since each of retaining members 48A-48D attach to tubes 14 in the same manner, the structural differences between retaining members 48 will be highlighted. Basket holder 52 of FIG. 3B includes ring 54 extending from a short side of basket 52. Ring 54 has a diameter of about 0.63 inches (1.6 cm) and is configured for receiving electronics 22. Short towel bar 56 of FIG. 3C extends about 5.5 inches (14 cm) from attachment sleeve 60 and long towel bar 58 of FIG. 3D extends about 11.5 inches (29.21 cm) from attachment sleeve 60. Both short towel bar 56 and long towel bar 58 curve upwardly at ends opposite attachment circles 60 for retaining linens such as towels 24. As shown in FIGS. 3A-3D, retaining members 48 are secured at desired locations along tubes 14 to form storage device 10.

FIG. 4 is a perspective view of top tube 66 being attached to inner telescoping tube 30 to from storage device 10. Shown in FIG. 4 are first straight tube 28A, second straight tube 28B, inner telescoping tube 30, outer telescoping tube 32, first end 34 of inner telescoping tube 30, top and bottom end caps 46A and 46B, retaining members 48A-48D, basket holder 50, basket holder 52 with ring 54, small towel bar 56, large towel bar 58, and top tube 66 having first end 68 and second end 70. Top tube 66 is added to the plurality of tubes 14 and retaining members 48 in order to complete the structure of storage device 10.

As described above with regard to FIG. 2, bottom end cap 46B is attached to the second end of second straight tube 28B and contacts a surface located in the second direction, such as a floor or a tub. Located above and attached to second straight tube 28B is first straight tube 28A. Located above and attached to first straight tube 28A is outer telescoping tube 32, which is located beneath and attached to inner telescoping tube 30. First end 34 of inner telescoping tube 30 faces the first direction, such as a ceiling. As described above with regards to FIGS. 3A-3D, basket holder 50, basket holder 52 with ring 54, small towel bar 56, and large towel bar 58 are attached at desirable locations along tubes 14. In the depicted embodiment, basket holder 50 is attached to outer telescoping tube 32, basket holder 52 with ring 54 and small towel bar 56 are attached to first straight tube 28A, and large towel bar 58 is attached to second straight tube 28B. Other configurations are equally possible.

Also shown in FIG. 4 is top tube 66 having first end 68 and opposite second end 70. Top tube is about 24 inches (60.96 cm) long and has a diameter of about 0.63 inches (1.6 cm). Top tube 66 is placed above inner telescoping tube 30, and top end cap 46A is placed above top telescoping tube 66. First end 68 of top tube 66 faces the first direction and receives top end cap 46A, which is configured for contact with a surface such as a ceiling. Second end 70 of top tube 66 faces the second direction, and is inserted into first end 34 of inner telescoping tube 30. Since the diameter of top tube 66 is less than the diameter of first end 34 of inner telescoping tube 30, second end 70 of top tube 66 is received into first end 34 of inner telescoping tube 30. With top tube 66 so arranged, the assembly of storage device 10 is nearly ready to retain and organize personal items.

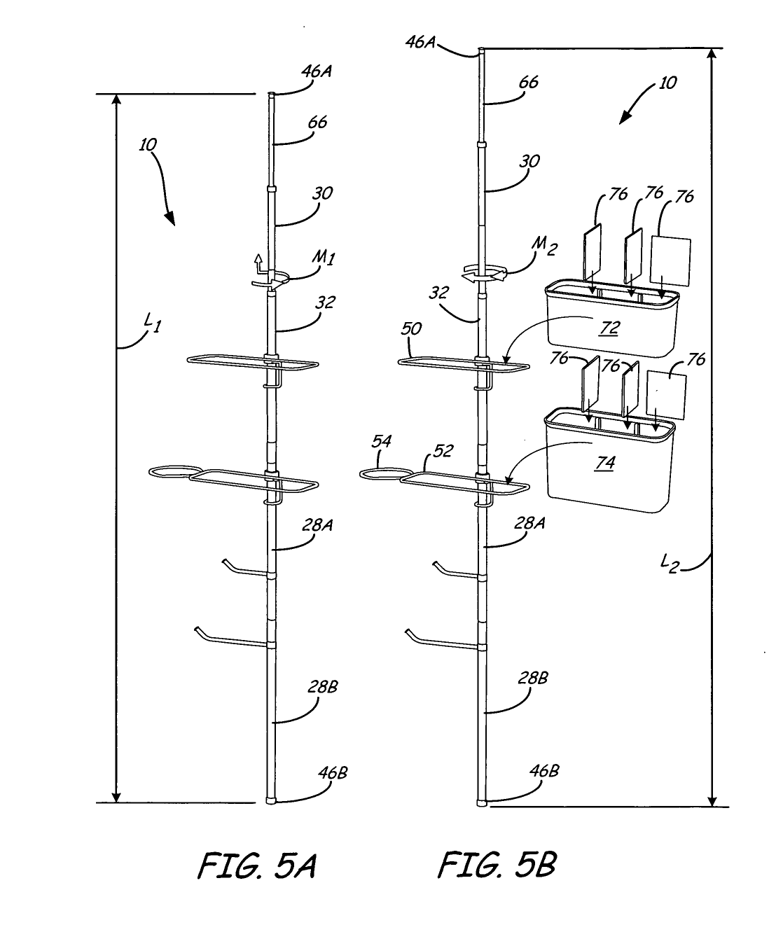

FIG. 5A depicts storage device 10 having overall length L, and FIG. 5B depicts storage device 10 having overall length L₂. Noted in FIGS. 5A and 5B are first straight tube 28A, second straight tube 28B, inner telescoping tube 30, outer telescoping tube 32, top and bottom end caps 46A and 46B, basket holder 50, basket holder 52 with ring 54, and top tube 66. Additionally in FIG. 5B are basket small basket 72, large basket 74, and dividers 76. The overall length of storage device 10 is adjustable between L₁ and L₂ to accommodate different distances between ceilings and floors.

In FIG. 5A, as measured from top end cap 46A to bottom end cap 46B (thereby including lengths of top tube 66, inner telescoping tube 30, outer telescoping tube 32, first straight tube 28A, and second straight tube 28B), the overall length of storage device 10 L₁ is about 93 inches (236.22 cm). Clockwise rotation of inner telescoping tube 30 with respect to outer telescoping tube 32 illustrated as movement M₁ allows for sliding movement between inner telescoping tube 30 and outer telescoping tube 32. The amount of inner telescoping tube 30 that is located within outer telescoping tube 32 can be reduced in order to increase an overall length of storage device 10. In other words, a user can pull inner telescoping tube 30 out away from its insertion into outer telescoping tube 32 (toward a first direction or ceiling) in order to increase the overall length of storage device 10.

As shown in FIG. 5B, the overall length of storage device has increased to L₂ as measured from top end cap 46A to bottom end cap 46B (thereby including lengths of top tube 66, extended inner telescoping tube 30, outer telescoping tube 32, first straight tube 28A, and second straight tube 28B) of about 111 inches (281.94 cm). Counter-clockwise rotation of inner telescoping tube 30 with respect to outer telescoping tube 32, illustrated as movement M₂, locks inner telescoping tube 30 and outer telescoping tube 32 at a chosen length such as L₂. The length of storage device 10 can be further altered by choosing either to include or not include second straight tube 28B. Inclusion of both first straight tube 28A and second straight tube 28B provides an overall length range for storage device 10 of about 91.69-108.19 inches (232.8-274.8 cm), depending on the amount of inner telescoping tube 30 that is inserted into outer telescoping tube 32. Exclusion of one of first straight tube 28A or second straight tube 28B provides an overall length range for storage device 10 of about 69.31-85.81 inches (176-217.9 cm) depending on the amount or inner telescoping tube 30 that is inserted into outer telescoping tube 32. Thus, the telescopic relationship of inner telescoping tube 30 and outer telescoping tube 32, as well as inclusion or exclusion of second straight tube 28B, provide a multitude of ways to customize the overall length of storage device 10 to fit any given space.

Also shown in FIG. 5B are small basket 72 for receipt into basket holder 50 and large basket 74 for receipt into basket holder 52. Both baskets 72, 74 are rectangular with rounded edges such that the outer contours of baskets 72, 74 are supported by the similarly shaped basket holders 50, 52. Both small basket 72 and large basket 74 have openings about 9 inches (22.86 cm) long and about 3.5 inches (8.89 cm) wide. Small basket 72 has a depth of about 2-4 inches (5.08-10.16 cm) while large basket 74 has a depth of about 6 inches (15.24 cm). Exploded from both small basket 72 and large basket 74 are dividers 76 for sub-dividing baskets 72, 74 into discrete portions. Baskets 72, 74 can be divided along a y-axis and/or a z-axis relative to an x-axis extending across a bottom surface of baskets 72, 74. Thus, dividers 76 organize personal items located within baskets 72, 74, which are supported by basket holders 50, 52 depending horizontally from vertical tubes 14 of storage device 10.

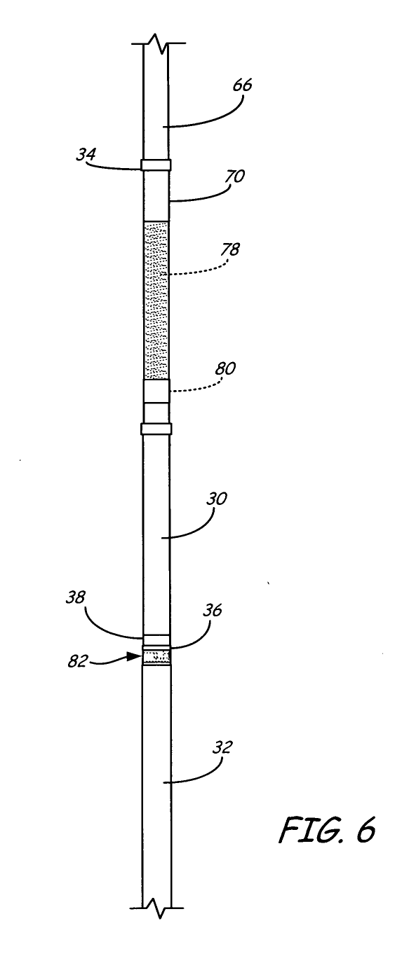

FIG. 6 is a side view of telescoping tube section 26 showing internal features spring 78, block 80, and cam-lock assembly 82 in phantom. Illustrated are inner telescoping tube 30, outer telescoping tube 32, first end 34 and second end 36 of inner telescoping tube 30, first end 38 of outer telescoping tube 32, top tube 66, second end 70 of top tube 66, spring 78, block 80, and cam-lock assembly 82. Spring 78, block 80, and cam-lock assembly 82 are responsible for the adjustable length of storage device 10.

Located within inner telescoping tube 30 are spring 78 and block 80. Spring 78 and block 80 are located closer to first end 34 than second end 36 of inner telescoping tube 30. Spring 78 is coiled and resilient while block 80 is solid. Block 80 is fixed near an approximate center of inner telescoping tube 30 and contains spring 78 within first end 34 of inner telescoping tube 30. Second end 70 of top tube 66 is inserted into first end 34 of inner telescoping tube 30 and contacts a first end of spring 78. Second end 70 of top tube 66 can push on the first end of spring 78 to adjust the amount of top tube 66 located within inner telescoping tube 30. Block 80 contacts a second end of spring 78, thereby allowing spring 78 to exhibit tension back toward top tube 66. Thus, spring 78 and stop 80 allows adjustment of top tube 66 relative to inner telescoping tube 30. Attached to second end 36 of inner telescoping tube 30 is cam-lock assembly 82. In the depicted embodiment, second end 36 of telescoping tube 30 (including cam-lock assembly 82), is inserted into first end 38 of outer telescoping tube 32. Cam-lock assembly 82 allows for the adjustable and locking relationship between inner telescoping tube 30 and outer telescoping tube 32, which is discussed in detail below.

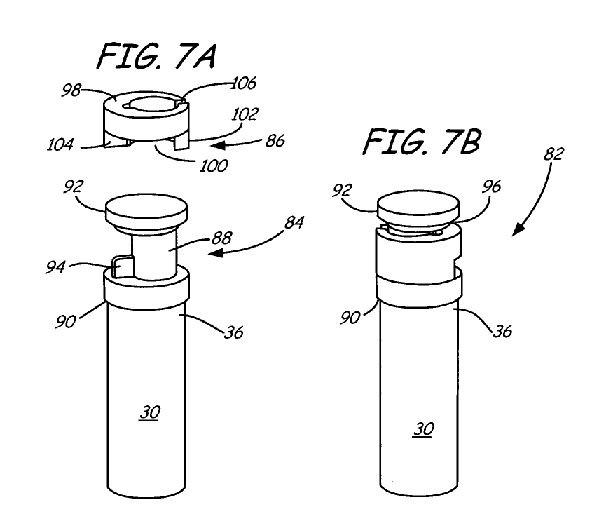

FIG. 7A is an exploded view and FIG. 7B is an assembled view of cam-lock assembly 82 attached to second end 36 of inner telescoping tube 30. Cam-lock assembly 82 includes spool 84 and eccentric bushing 86. Spool 84 includes post 88, first flange 90, second flange 82, stop 94, and track 96; and eccentric bushing 86 includes wall 98, cut-out 100, first side 102, second side 104, and space 106. Cam-lock assembly 82 is configured to allow both sliding movement and locked engagement between inner telescoping tube 30 and outer telescoping tube 32.

Cam-lock assembly 82 can be formed of plastic or any other suitable material and includes two main portions: spool 84 and eccentric bushing 86. Spool 84 includes cylindrical post 88 extending between first flange 90 and second flange 92. A first end of post 88 is attached to first flange 90 and a second end of post 88 is attached to second flange 92. Post 88 is has a length of about 0.5 inches (1.27 cm) and is offset from a common vertical axis of first flange 90 and second flange 92. First flange 90 and second flange 92 are co-axial discs having diameters of about 0.75 inches (1.91 cm). First flange 90 is attached between second end 36 of inner telescoping tube 30 and a first end of post 88. First flange 90 has a uniform thickness of about 0.25 inches (0.635 cm). Second flange 92 is attached to second end of post 88 and has an overall thickness of about 0.19 inches (0.48 cm). The thickness of second flange 92 is divided evenly between a top disc having a larger diameter of about 0.75 inches (1.91 cm) and a bottom disc having a slightly smaller diameter that is attached second end of spool 88. Attached to one side of spool 88 and first flange 90 is stop 94. Stop 94 is rectangular in shape with rounded edges. Stop 94 extends upwardly from first flange 90 about 0.13 inches (0.33 cm) and outwardly from spool 88 about 0.13 inches (0.33 cm). Stop 94 is located in track 96, which is the space radially surrounding spool 88.

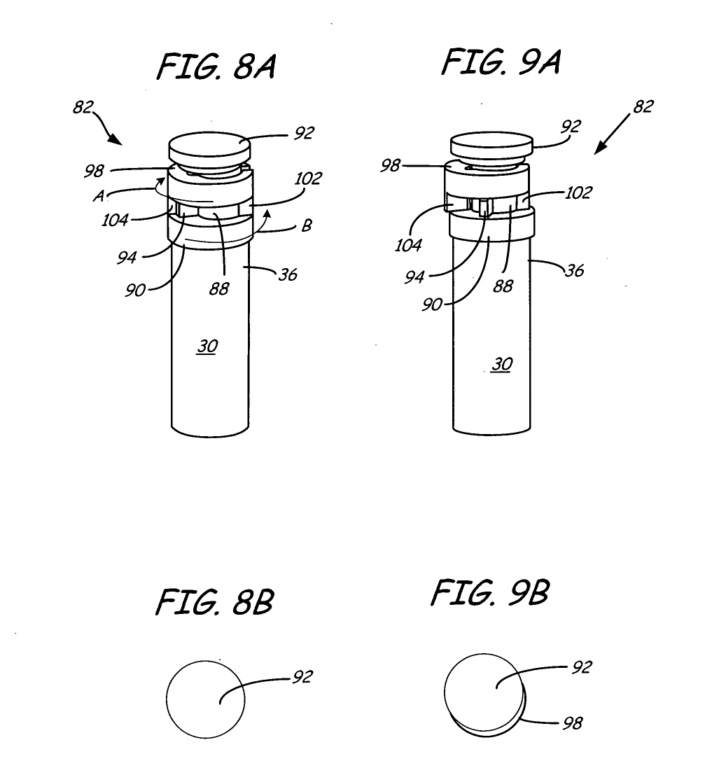

Eccentric bushing 86 is exploded from spool 84 in FIG. 7A and assembled for use (located in track 96) in FIG. 7B. Eccentric bushing 86 is donut shaped in that wall 98 extends circularly around a central hole. Wall 98 has an overall height of about 0.38 inches (0.97 cm) and cut-out 100 extends upwardly into one side of wall 98 about 0.19 inches (0.48 cm). Cut-out 100 extends about half-way around the circular wall 98 from a first side 102 to a second side 104. Located just behind first side 102 is space 106, which extends vertically through wall 98 to form a gap therein. Space 106 allows wall 98 to expand slightly and assume its assembled position within track 96 between first flange 90 and second flange 92 of spool 84, as depicted in FIG. 7B. An inner surface of wall 98, which defines the central hole of eccentric bushing 86, will surround spool 88 in the assembled position. A bottom surface of wall 98 faces first flange 90 and a top surface of wall 98 faces second flange 92. Cut-out-100 allows bushing 86 to rotate about post 88 from a position where first side 102 contacts stop 94 to a position where second side 104 contacts stop 94. The function of cam-lock assembly 82 is described further with regards to FIGS. 8A-8B and 9A-9B.

FIG. 8A is a perspective view and FIG. 8B is a top view of cam-lock assembly 82 in an unlocked or released position. FIG. 9A is a perspective view and FIG. 9B is a top view of cam-lock assembly 82 approaching a locked position. Visible in FIGS. 8A-B and 9A-B are inner telescoping tube 30, second end 36 of inner telescoping tube 30, and components of cam-lock assembly 82: post 88, first flange 90, second flange 92, stop 94, wall 98, first side 102, and second side 104. When viewed in series, FIGS. 8A-8B and 9A-9B illustrate how cam-lock assembly 82 forms an adjustable but locking relationship between inner telescoping tube 30 and outer telescoping tube 32.

In FIGS. 8A-8B, cam-locking assembly 82 is in a released or unlocked position that allows for sliding movement between telescoping tube section 26. When viewed from the side (FIG. 8A), second wall 104 is in contact with stop 94. When viewed from the top (FIG. 8B), wall 98 of eccentric bushing 86 does not extend beyond the diameters first flange 90 or second flange 92 of spool 82. In this unlocked position, cam-lock assembly 82 is loosely in line with second end 36 of inner telescoping tube 30 allowing first end 38 of outer telescoping tube 32 to slide over cam-lock assembly 82 into sliding engagement with inner telescoping tube 30. Since there is clearance between the diameters of telescoping tube section 26, outer telescoping tube 32 can continue to slide along inner telescoping tube 30 to adjust the overall length of telescoping tube section 26 (see FIGS. 5A-5B). Once a desired length of telescoping tube section 26 is achieved, cam-lock assembly 82 can be locked by rotating outer telescoping tube 32 with respect to inner telescoping tube 30. Rotational movement of outer telescoping tube 32 in the direction of arrow A (counter-clockwise) causes eccentric bushing 86 to move in the direction of arrow A. Rotational movement of inner telescoping tube 30 in the direction of arrow B causes spool 84 to move in the direction of arrow B (clockwise). Rotation of either outer telescoping tube 32 or inner telescoping tube 30 will cause cam-lock assembly 82 to leave the released position illustrated in FIGS. 8A-8B and approach a locked position illustrated in FIGS. 9A-9B. More specifically, eccentric bushing 86 is driven around spool 84 in the direction of arrow A and/or spool 84 is driven in the direction of arrow B by rotational movement of inner telescoping tube 30 and/or outer telescoping tube 32 until an inner surface of outer telescoping tube 32 frictionally engages an outer surface of eccentric bushing 86.

In FIGS. 9A-9B, wall 98 of eccentric bushing 86 extends beyond the diameters of first flange 90 and second flange 92 of spool 84. Stop 94 is located part way between first side 102 and second side 104 of cutout 100. When first side 102 reaches stop 94, cam-lock assembly 82 will have reached a fully locked position. Even prior to achieving the fully locked position, wall 98 begins to extend beyond first flange 90 and second flange 92 into the space between inner telescoping tube 30 and outer telescoping tube 32. Since eccentric bushing 86 is occupying the space between inner telescoping tube 30 and outer telescoping 32; the tubes are no longer capable of sliding with respect to one another and become fixed at a particular length. An outside surface the eccentric bushing 86 will assume an interference fit with an inside surface of outer telescoping tube 32 when cam-lock assembly 82 is in the locked position. Cam-lock assembly 82 is easily unlocked by reversing the rotational movement depicted by arrows A & B such that eccentric bushing resumes the configuration shown in FIGS. 8A-8B. Cam-lock assembly 82 can be used on any telescoping tubes where adjustability and locking are desired characteristics.

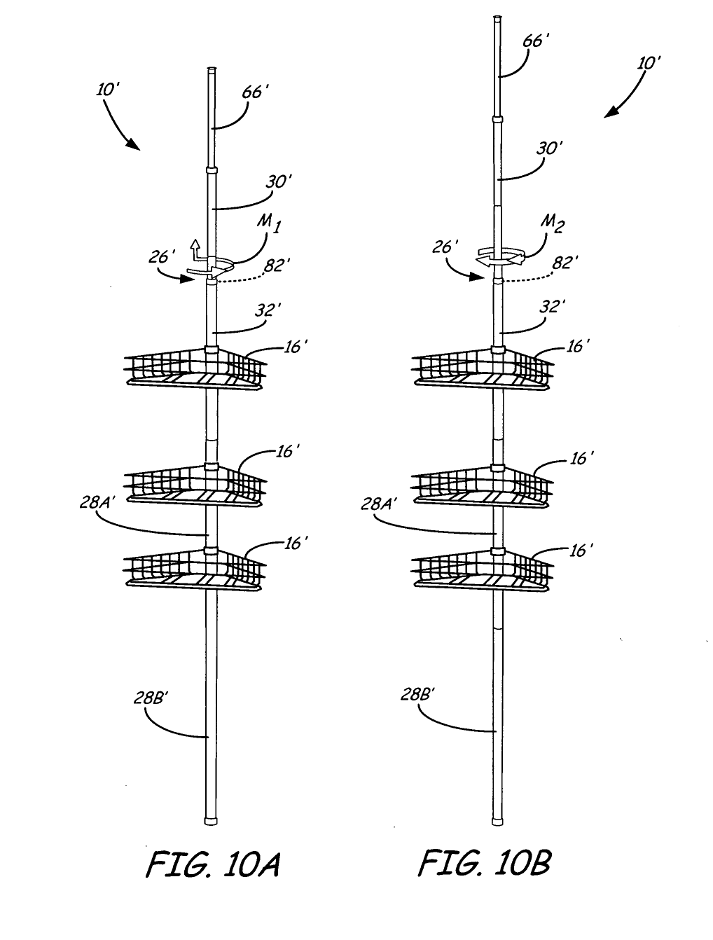

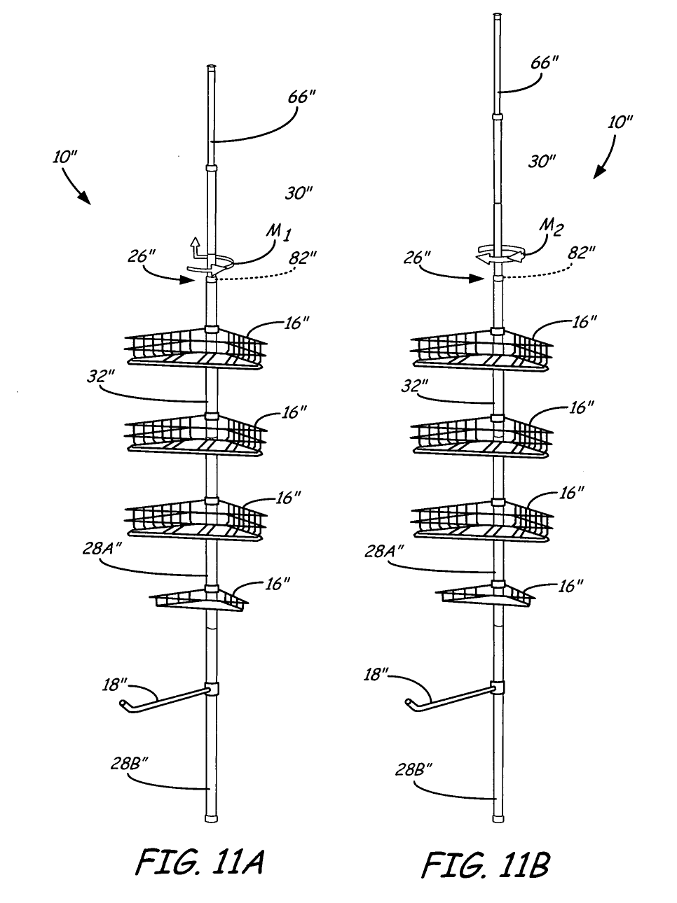

FIGS. 10A-10B are perspective views of alternative storage device 10′ having cam-lock assembly 82′ on telescoping tube section 26′. Depicted in FIGS. 10A-10B are components of alternative storage device 10′: baskets 16′, telescoping tube section 26′, first straight tube 28A′, second straight tube 28B′, inner telescoping tube 30′, outer telescoping tube 32′, top tube 66′, and cam-lock assembly 82′. Storage device 10′ is similar to storage device 10 described in FIGS. 1-9B.

Storage device 10′ has a tubular vertical structure similar to that of storage device 10, which includes telescoping tube section 26′ (inner telescoping tube 30′ and outer telescoping tube 32′), first straight tube 28A′, second straight tube 28B′, and top tube 66′. Just as with storage device 10, cam-lock assembly 82′ is located on inner telescoping tube 30′ to provide both an sliding and locking relationship to telescoping tube section 26′. The height of telescoping tube section 26′ can be adjusted upwards by rotating inner telescoping tube 30′ in the direction of M₁, pulling inner telescoping tube 30′ further out of outer telescoping tube 32′, and rotating inner telescoping tube 30′ in the opposite direction M₂. FIGS. 10A-10B depict how lengthening of telescoping tube section 26′ can change an overall height of storage device 10′. Distinguishing storage device 10′ from storage device 10, are baskets 16′. Instead of retaining members 48 (including basket holders 50, 52 receiving baskets 72, 74, and towel bars 56, 58), storage device 10′ includes three wire baskets 16′ spaced along outer telescoping tube 30′, first straight tube 28A′, and second straight tube 28B′ for organizing and retaining personal items. Baskets 16′ can be formed from wire, mesh, plastic, or any combination of these materials. Baskets 16′ can be identical or different in size. The material, size, shape, and configuration of baskets 16′ can vary widely so long as storage device 10′ includes cam-lock assembly 82′ for adjusting and locking telescoping tube section 26′.

FIGS. 11A-11B are perspective views of alternative storage device 10″ having cam-lock assembly 82″ on telescoping tube section 26″. Depicted in FIGS. 11A-11B are components of storage device 10″: baskets 16″, bars 18″, telescoping tube section 26″, first straight tube 28A″, second straight tube 28B″, inner telescoping tube 30″, outer telescoping tube 32″, top tube 66″, and cam-lock assembly 82″. Storage device 10″ is similar to storage device 10 described in FIGS. 1-9B, as well as storage device 10′ described in FIGS. 10A-10B.

Storage device 10″ has a tubular vertical structure similar to that of storage device 10 and storage device 10′, which includes telescoping tube section 26″ (inner telescoping tube 30″ and outer telescoping tube 32″), first straight tube 28A″, second straight tube 28B″, and top tube 66″. Just as with storage device 10 and storage device 10′, cam-lock assembly 82″ is located on inner telescoping tube 30″ to provide both a sliding and locking relationship to telescoping tube section 26″. The height of telescoping tube section 26″ can be adjusted upwards by rotating inner telescoping tube 30″ in the direction of M_{I}, pulling inner telescoping tube 30″ further out of outer telescoping tube 32″, and rotating inner telescoping tube 30″ in the opposite direction M₂. FIGS. 11A-11B depict how lengthening of telescoping tube section 26″ can change an overall height of storage device 10″. Like storage device 10′, storage device 10″ includes baskets 16″. As shown in FIGS. 11A-11B, baskets 16″ can be formed of wire and be various sizes. Distinguishing storage device 10″ from storage device 10′, is bar 18″. Instead of solely baskets 16″, storage device 10″ also includes bar 18″. The means of organizing and storing personal items can vary widely so long as storage device 10″ includes cam-lock assembly 82″ for adjusting and locking telescoping tube section 26″.

FIG. 12 is a perspective view of alternative storage device 10′ having cam-lock assembly 82″ on telescoping tube section 26″. Depicted in 12 are components of storage device 10′″: telescoping tube section 26″, first straight tube 28A″, inner telescoping tube 30″, outer telescoping tube 32′, cam-lock assembly 82′, and shelves 106. Storage device 10″ is similar to storage device 10 described in FIGS. 1-9B, as well as storage device 10′ described in FIGS. 10A-10B and storage device 10″ described in FIGS. 11A-11B.

Similar to the previous embodiments, storage device 10′″ includes telescoping tube section 26′ (inner telescoping tube 30′″ and outer telescoping tube 32″), and first straight tube 28A″. Just as with the previous embodiments, storage device 10′″ includes cam-lock assembly 82″ on inner telescoping tube 30′″ to provide both a sliding and locking relationship to telescoping tube section 26′. The length of telescoping tube section 26′″ can be adjusted by rotating inner telescoping tube 30′, pulling inner telescoping tube 30′ further out of outer telescoping tube 32′, and rotating inner telescoping tube 30′″ in the opposite. Storage device 10′ has a tubular horizontal structure in contrast to the vertical structure of storage device 10, storage device 10′, and storage device 10″. Two parallel sets of tubes, each including telescoping tube section 26″ (inner telescoping tube 30′″ and outer telescoping tube 32′) and first straight tube 28A′″ extend horizontally between two walls to support a plurality of shelves 106. Any of straight tube 28A″, inner telescoping tube 30′″ and outer telescoping tube 32′ can include a spring bias. Once again, the means of organizing and storing personal items, and well as the direction of the tubular storage device, can vary widely so long as storage device 10′″ includes cam-lock assembly 82″ for adjusting and locking telescoping tube section 26′.

Although the present invention has been described with reference to preferred embodiments, workers skilled in the art will recognize that changes may be made in form and detail without departing from the spirit and scope of the invention.

1. A device comprising:
an inner tube and an outer tube; and
a cam-lock assembly located at an end of the inner tube inserted into the outer tube, the cam-lock assembly including a spool and an eccentric bushing surrounding the spool,
wherein the inner tube and the outer tube slide with respect to one another to adjust an overall length of the device when the cam-lock assembly is in a released position, and rotation of one of the inner tube and the outer tube engages the eccentric bushing to drive it around the spool into a locked position such that the first tube and the second tube are fixed at a particular length.

2. The device of claim 1, wherein the spool comprises:
a first flange attached to the end of the inner tube, the first flange having a diameter similar to a diameter of the inner tube,
a second flange coaxial with the first flange, the second flange having a diameter similar to the diameter of the first flange; and
a cylindrical post extending between the first flange and the second flange, the cylindrical post being offset from the common axis of the first flange and the second flange, wherein an area surrounding the cylindrical post forms a track for the eccentric bushing.

3. The device of claim 2, wherein the eccentric bushing is located in the track and surrounds the cylindrical post without extending beyond the diameter of the first flange when the cam-lock assembly is in the released position.

4. The device of claim 3, wherein the eccentric bushing extends beyond the diameter of the first flange when the cam-lock assembly is in the locked position.

5. The device of claim 2, wherein the spool further comprises:
a stop extending into the track.

6. The device of claim 5, wherein the eccentric bushing comprises:
a cut-out for allowing rotation around the cylindrical post; and
a wall for engaging the stop.

7. The device of claim 1, wherein an outside surface of the eccentric bushing assumes an interference fit with an inside surface of the outer tube when the cam-lock assembly is in the locked position.

8. The device of claim 1, wherein rotation of the outer tube counter-clockwise engages the eccentric bushing and brings the cam-lock assembly into the locked position.

9. The device of claim 1, further comprising:
a storage apparatus attached to one of the inner tube and the outer tube.

10. A device comprising:
an inner tube and an outer tube; and
a cam-lock assembly located at an end of the inner tube inserted into the outer tube, the cam-lock assembly comprising:
a first flange attached to the end of the inner tube, the first flange having a diameter similar to a diameter of the inner tube,
a second flange coaxial with the first flange, the second flange having a diameter similar to the diameter of the first flange;
a cylindrical post extending between the first flange and the second flange, the cylindrical post being offset from the common axis of the first flange and the second flange, wherein an area surrounding the cylindrical post forms a track; and
an eccentric bushing in the track surrounding the post,
wherein the inner tube and the outer tube slide with respect to one another to adjust an overall length when the cam-lock assembly is in a released position, and rotation of the outer tube frictionally engages the eccentric bushing to drive it around the cylindrical post into a locked position such that the first tube and the second tube are fixed at a particular length.

11. The device of claim 10, wherein an outer surface of the eccentric bushing is loosely aligned with the diameter of the first flange in the released position.

12. The device of claim 11, wherein the eccentric bushing extends beyond the diameter of the first flange in the locked position.

13. The device of claim 10, wherein the spool further comprises:
a stop extending into the track.

14. The device of claim 13, wherein the eccentric bushing comprises:
a cut-out allowing for rotation around the cylindrical post; and
a wall for engaging the stop.

15. A storage assembly comprising:
a plurality of tubes assembled to form a unit, the plurality of tubes including an inner tube and an outer tube telescopically engaged with one another to adjust an overall length of the unit;
at least one storage apparatus attached to one of the plurality of tubes; and
a cam-lock assembly located at an end of the inner tube inserted into the outer tube, wherein rotation of one of the inner tube and the outer tube engages the cam-lock assembly such that the first tube and the second tube are fixed at a particular length.

16. The storage assembly of claim 15, wherein the at least one storage apparatus is a basket.

17. The storage assembly of claim 16, wherein a wire holder extends from one of the plurality of tubes to support the basket.

18. The storage assembly of claim 17, wherein the wire holder includes a towel ring.

19. The storage assembly of claim 15, further comprising:
a towel bar attached to one of the plurality of tubes.

20. The storage assembly of claim 15, wherein the unit is oriented vertically and extends between a ceiling and a floor.
